(19) United States
(12) Patent Application Publication
(10) Pub. No.: US 2021/0253179 A1
(43) Pub. Date: Aug. 19, 2021

(54) Utility Trailer

(71) Applicant: R-N-R International, Inc., Elkhart, IN (US)

(72) Inventor: Stewart E. Gardner, Elkhart, IN (US)

(73) Assignee: R-N-R International, Inc., Elkhart, IN (US)

(21) Appl. No.: 17/175,304

(22) Filed: Feb. 12, 2021

Related U.S. Application Data
(60) Provisional application No. 62/976,891, filed on Feb. 14, 2020.

(51) Int. Cl. B62D 25/20; B62D 63/06; B60R 16/03; B62D 63/08; B62D 21/11

(52) U.S. Cl. CPC B62D 25/20; B62D 63/062; B62D 21/11; B62D 63/08; B60R 16/03

(57) ABSTRACT

The utility trailer uses a semi-monocoque deck to eliminate the need for deck frames. The semi-monocoque deck is bolted atop an axle support structure and tongue assembly. The monocoque deck includes a deck floor bonded to a corrugated sub-floor to replace the framed structural support of traditional trailers. The corrugation sub-panel provides longitudinal rigidity to the deck and bonding the deck floor to the sub-panel provides lateral rigidity.

This application claims the benefit of U.S. Provisional Application No. 62/976,891 filed Feb. 14, 2020, the disclosure of which is hereby incorporated by reference.

This invention relates to tow-behind trailers, and in particular, light weight trailers with a frame-less deck.

### BACKGROUND AND SUMMARY OF THE INVENTION

Light-duty, tow-behind utility trailers traditionally follow the same designs as heavy-duty utility trailers. Both flat bed and box style trailers have a framed deck carried atop a tongue and axle assembly. Framed decks include a deck floor supported by a deck frame. The deck frames use a variety of longitudinal and lateral beams and braces that support and distribute the load across the trailer deck. While sturdy and reliable, the framed decks raise the overall height of the trailer floor and increase the weight and cost of the trailer.

The utility trailers embodying the present invention are light-duty utility trailers that use a semi-monocoque deck to eliminate the need for deck frames. The semi-monocoque deck is bolted atop an axle support structure and tongue assembly. The monocoque deck includes a deck floor bonded and fastened to a corrugated sub-floor to replace the framed structural support of traditional trailers. The deck floor is an engineered composite or laminar substrate that is typically cut or constructed from sheets of plastic composites or waterproof wood composites, such as plywood or oriented strand board (“OSB”). The corrugated sub-panel is a sheet of suitable metal, such as steel or aluminum, which is rolled or pressed to produce a series of flat parallel ridges and furrows. The corrugation of the sub-panel provides longitudinal rigidity to the deck and bonding the deck floor to the sub-panel provides lateral rigidity. Eliminating the framed decks lowers the overall height of the trailer floor and reduces the weight and cost of the trailer, making the trailer ideal for light duty applications.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is an exploded view of a prior art trailer;

FIG. 2 a perspective view with portions of the railing cutaway of an exemplary embodiment of the trailer of this invention;

FIG. 3 is an exploded view of the trailer of FIG. 1;

FIG. 4 is an exploded view of the deck used in the trailer of FIG. 1;

FIG. 5 is a partial sectional view of the deck of FIG. 4;

FIG. 6 is an exploded view of the axle support assembly, axle assembly and tongue assembly deck used in the trailer of FIG. 1;

FIG. 7 is a top view of the trailer of FIG. 1 with portions of the deck cutaway;

FIG. 8 is a side view of the trailer of FIG. 1;

FIG. 9 is a partial end sectional view of the trailer of FIG. 1;

FIG. 10 is another partial end sectional view of the trailer of FIG. 1; and

FIG. 11 is a partial end section view of a trailer with an alternative embodiment of the axle support assembly.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

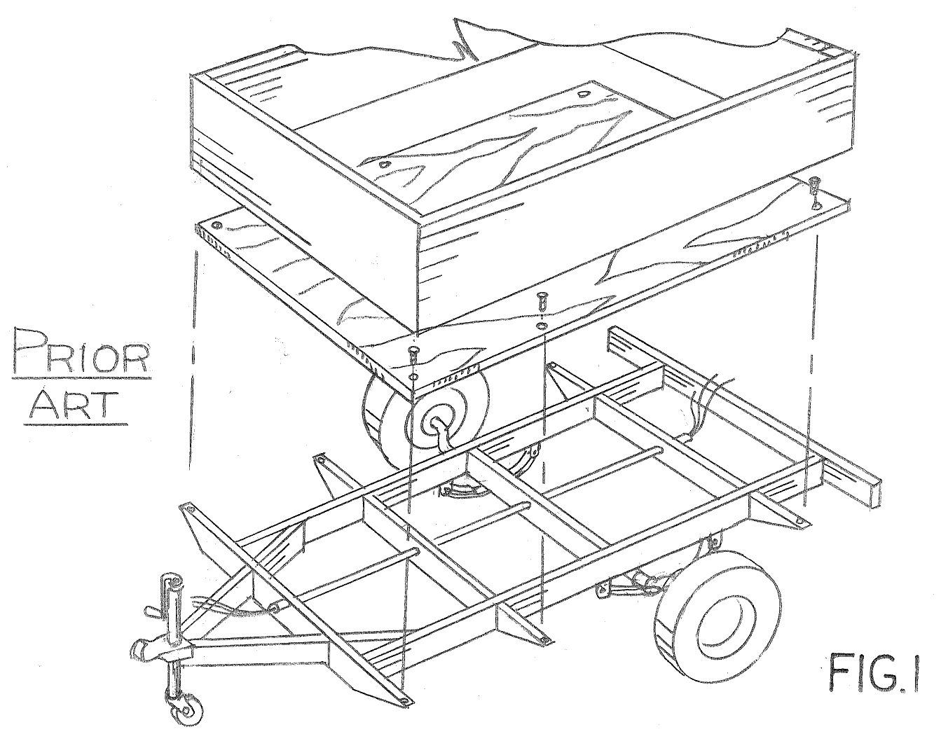

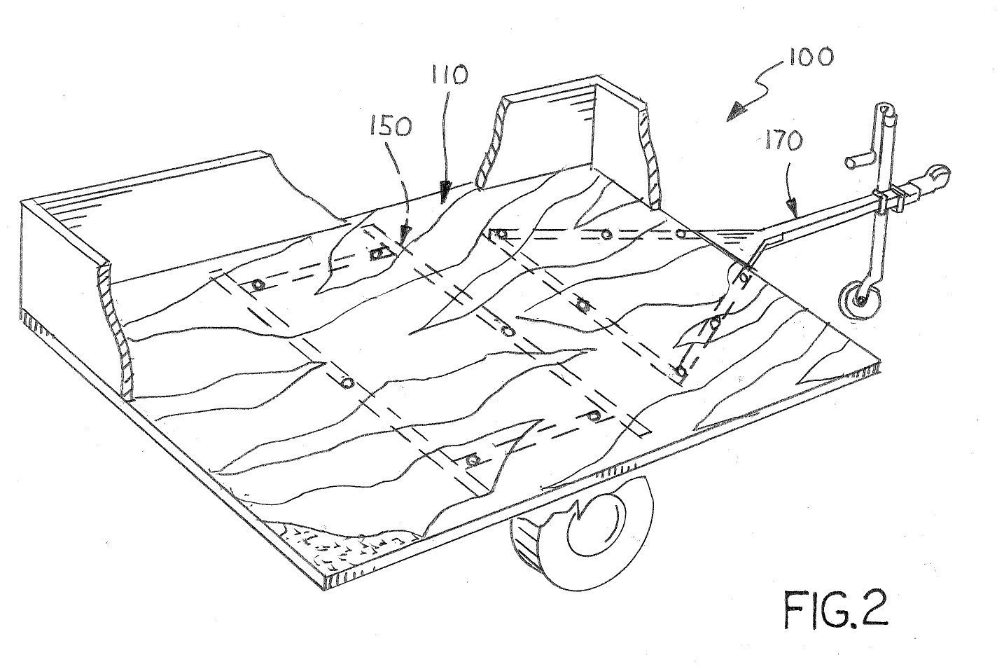

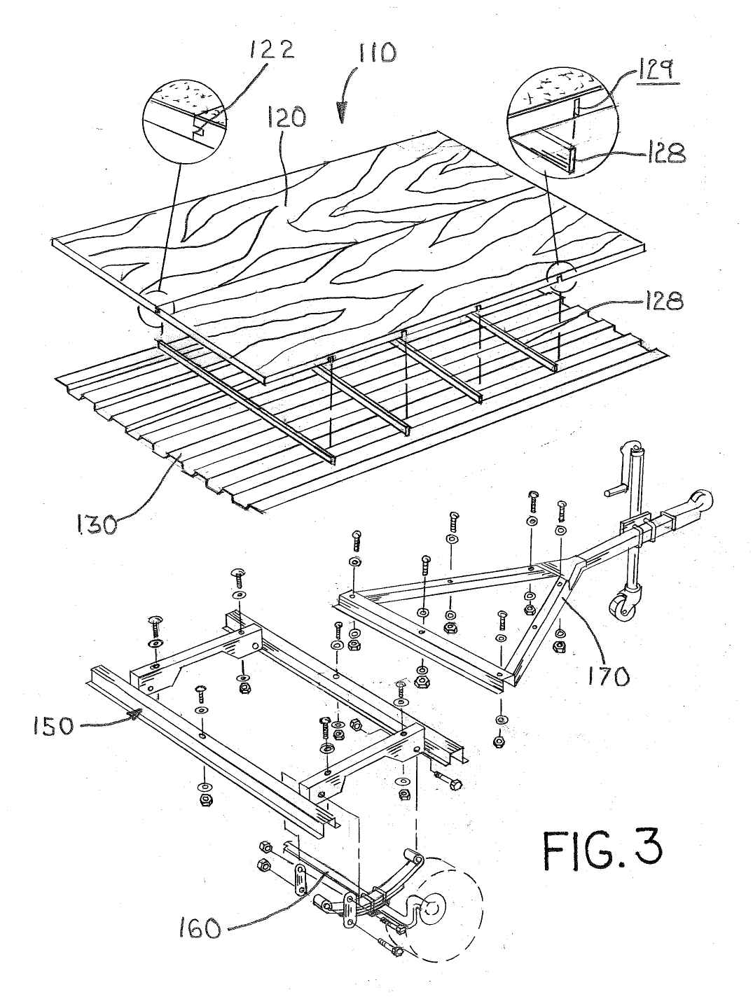

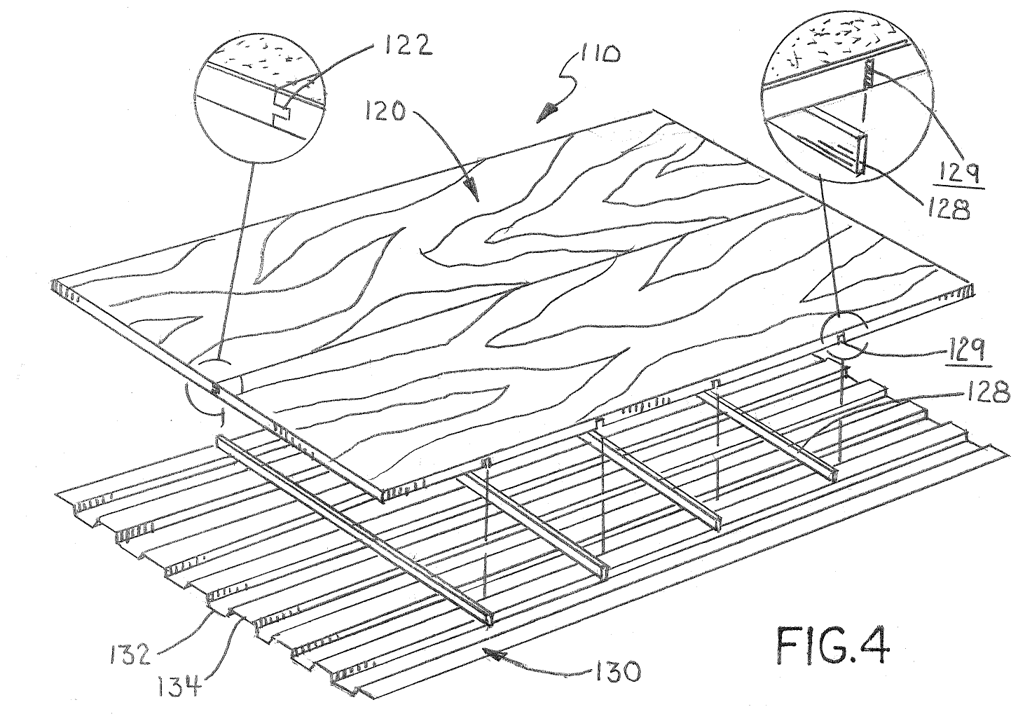

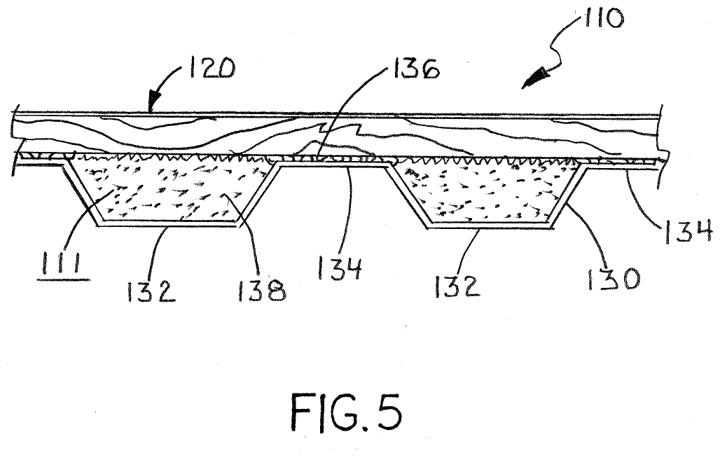

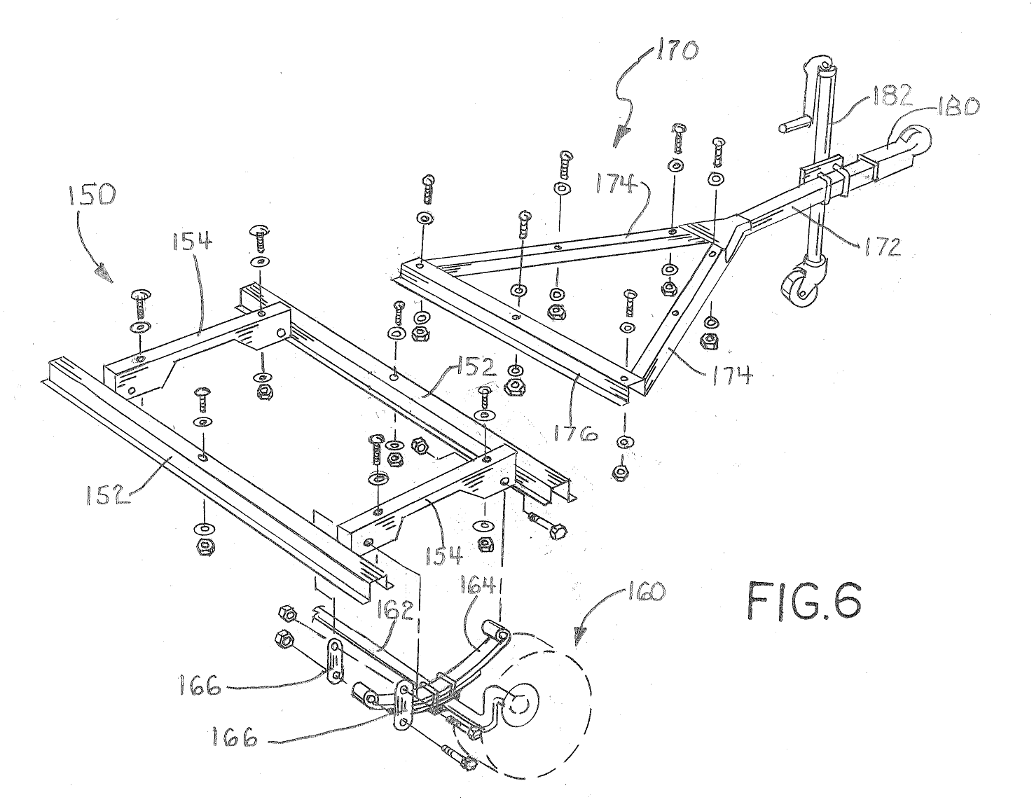

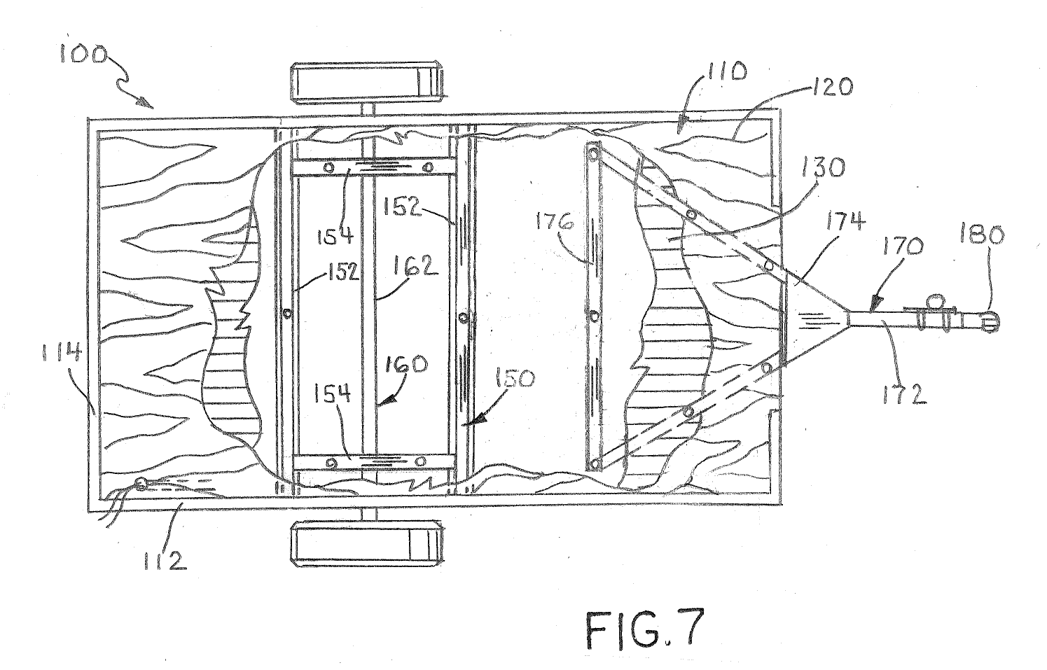

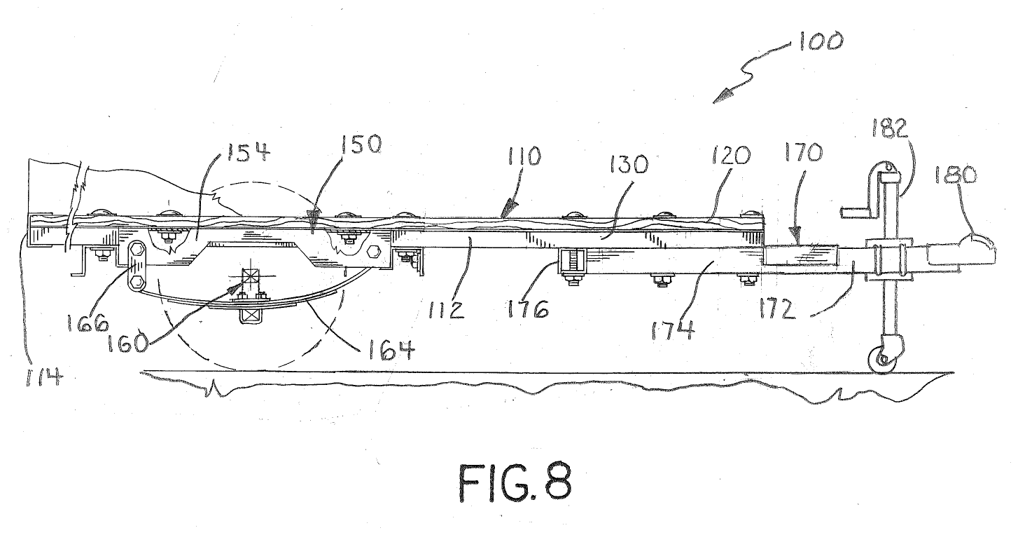

Referring now to the drawings, FIGS. 1-10 illustrate an exemplary embodiment of the frame-less trailer of this invention, which is designated generally as reference numeral 100. For simplicity of illustration and explanation, trailer 100 is depicted as a light-duty, utility trailer. While depicted as a utility trailer, the teaching may be applied to other types of towable utility trailers in other exemplary embodiments.

Trailer 100 is built on a semi-monocoque deck 110 with an axle support structure 150, a conventional axle assembly 160; and tongue assembly 170 mounted to the deck. Monocoque deck 110 includes a deck floor 120 and a corrugated sub-floor 130. Deck floor 120 is constructed from sheets of engineered composite or laminar substrates. In certain embodiments, deck floor 120 takes the form of polymer panel consisting of a planar honeycomb core sandwiched between and bonded to outer skins. In other embodiments, deck floor 120 is cut or constructed from sheets of waterproof wood composite, such as plywood or oriented strand board (“OSB”). Deck floor 120 may be coated with various paints, sealants and coating to provide weather proofing and texturing to its surfaces and edges as needed.

Corrugated sub-panel 130 is a sheet of suitable metal, such as steel or aluminum, which is rolled or pressed to produce a series of flat parallel ridges 132 and furrows 134. Top panel 120 and corrugated sub-panel 130 are thermal bonded together with a suitable adhesive with flats of ridges 132 of corrugated sub-panel 130 affixed to the bottom face of top panel 120. As shown, the corrugation of sub-panel 130 runs longitudinal to the trailer's direction of travel.

Corrugated sub-floor 130 is bonded to deck floor 120 to replace the structural support of traditional trailer frames and provides lateral and longitudinal rigidity to deck floor 120. Corrugation sub-floor 130 increases longitudinal rigidity in the direction of the corrugations and bonding deck floor 120 to corrugated sub-panel 130 provides additional structural rigidity perpendicular to the direction of the corrugation. Typically, the thickness of deck floor 120 and gauge of corrugated sub-panel 130 are selected to provide support for the intended load of the trailer. The pattern, configuration and dimension of the corrugations are selected to provide the desired lateral and longitudinal integrity to deck floor 120. End trim 140 is fastened to the ends of deck 110 to enclose open corrugation channels 131 between deck floor 120 and the corrugated sub-floor 130. Similarly, side trim 140 is fastened to side edges of deck 110 to enclose the edges of deck floor 120 and corrugated sub-floor 130.

In constructing deck floor 120, various sheets of flooring materials may be cut, assembled and bonded together into a unitary top floor. In certain applications depending on trailer dimensions, multiple sheets may be joined together using a tongue and groove connection or other methods, or multiple sheets may be aligned in overlapping orientations to form the unitary top floor. In addition, deck floor 120 may incorporate internal stiffeners to provide more structural rigidity. As shown, the internal stiffeners may take the form of internal cross members 128 that are seating in lateral grooves 129 or bores formed or cut in the bottom of deck floor 120.

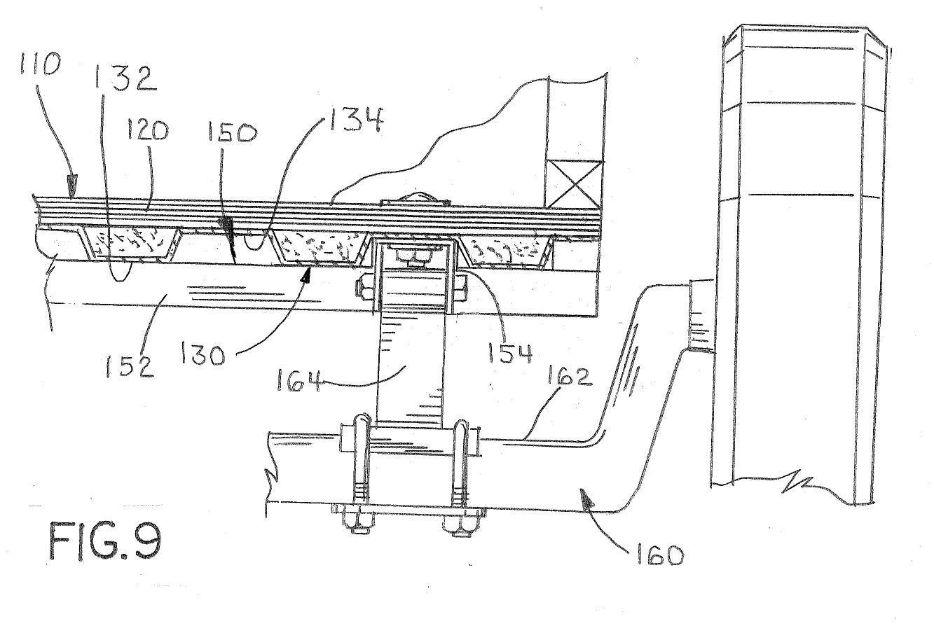

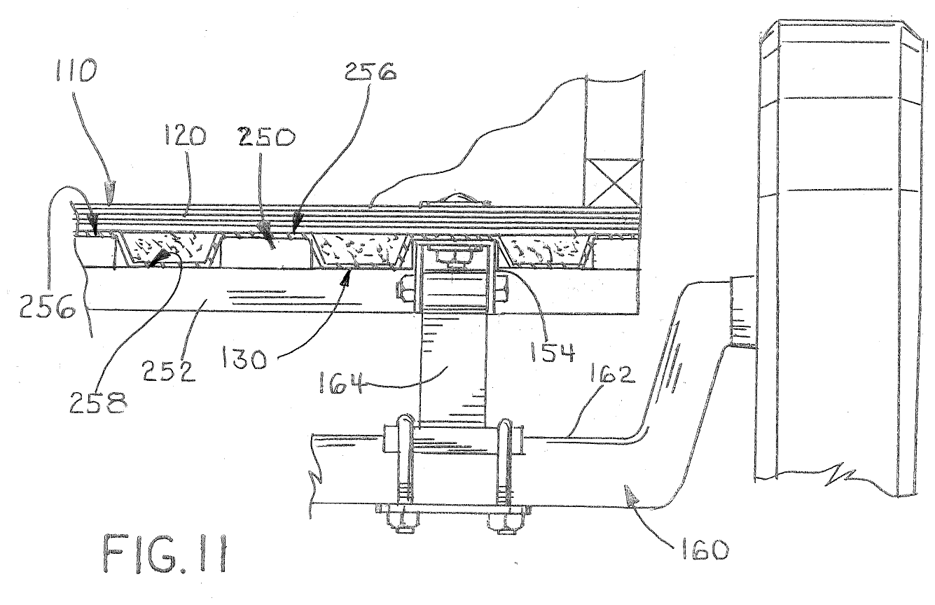

Axle support 150 is a separate structure affixed to the underside of deck 100 to support axle assembly 160 and help distribute the load of trailer 100 to the axle assembly. Axle support 150 is bolted to the underside of monocoque deck 110 using conventional bolt fasteners. Axle support 150 includes a pair of cross members 152 and a pair of spring hangers 154. Cross members 152 extend laterally across the width of the underside of deck 110. Cross members 152 abut flat against the ridges 132 of corrugated sub-floor 130 and are secured to the sub-floor using adhesives and bolt and nut fasteners (FIG. 9). Spring hangers 154 seat within corresponding furrows 134 of corrugated sub-floor 130 and are secured to deck 110 by bolt and nut fasteners that extend through aligned holes in the hangers and deck (FIG. 9). Spring hangers 154 are also welded between cross members 152 to provide a sturdy support structure for axle assembly 160. In alternative embodiments of the axle support assembly 200, cross members 252 may be configured to have a plurality of surfaces 256 and 258 that abut against the ridges 132 and nest within furrows 134 of sub-floor 130 (FIG. 11). The configuration of cross members 252 increase the interface area between axle support assembly 250 and deck 110, which further improves the structural integrity of the deck.

Axle assembly 160 is of conventional design and operation and includes an axle shaft 162, a pair of leaf springs 164 and a pair of spring links 166, as well as a pair of wheel hubs and tires. Conventional U-bolts secure axle 162 to leaf springs 164. Leaf springs 164 and spring links 166 nest within spring hangers 154 and are connected by bolts and hex nut fasteners.

Tongue assembly 170 is a separate structure affixed to the underside of the deck 110, which allows trailer 100 to be hitched to a tow vehicle (not shown). Tongue assembly 170 includes a tongue arm 172, a pair of angled brace arms 174, and a cross member 176 welded together as a single structure. Tongue assembly 170 is affixed to the underside of deck 110 and secured by bolt and nut fasteners that extend through aligned holes in the deck and assembly. Tongue assembly 170 also includes a conventional hitch coupler 180 and lift jack 182. Hitch coupler 180 attaches to the trailer ball of the tow vehicle.

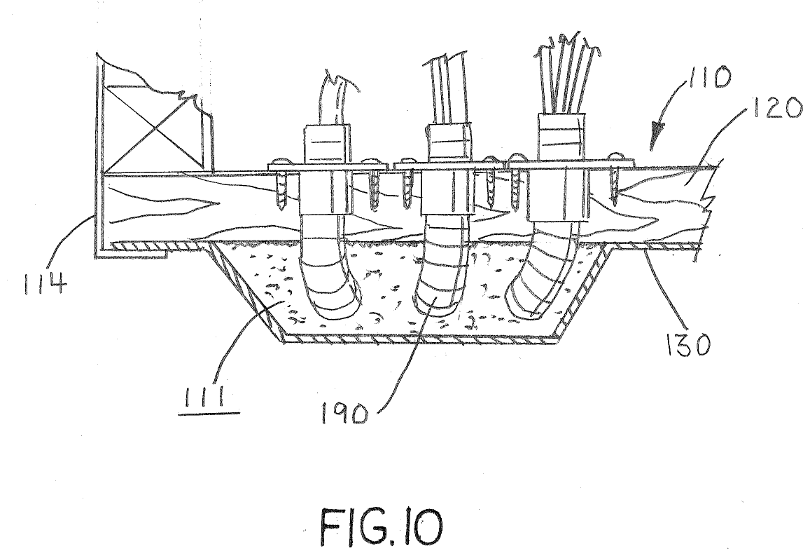

Trailer 100 may be fitted with conventional brake and tail light components (not shown) in desired locations. Corrugation sub-floor 130 has a plurality of longitudinal channels 131 that provide convenient wiring conduits (FIG. 10). Corrugation channels 131 allow electrical wires to be internally run within deck 110 the entire length of trailer 100. Tail and brake lights can be mounted on wheel fenders (not shown) or directly to deck 110 without having exposed wiring run on the underside of the deck.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A trailer assembly comprising:
a deck, the deck includes a planar deck floor and a corrugated sub-floor bonded to the bottom surface of the deck floor, the corrugated sub-floor having a plurality of parallel ridges and furrows defining a plurality of channels within the deck;
an axle assembly mounted to the deck; and
a tongue assembly mounted beneath the deck against the sub-floor.

2. The trailer of claim 1 wherein the plurality of parallel ridges of the sub-floor abut against and are bonded to the bottom surface of the deck floor.

3. The trailer of claim 1 wherein the axle assembly includes an axle support structure mounted beneath the deck against the sub-floor for connecting the axle assembly to the deck.

4. The trailer of claim 3 wherein the axle support structure includes a pair of cross members mounted to the sub-floor and a pair of spring hangers affixed between the pair of cross members.

5. The trailer of claim 4 wherein the cross members are configured to have a plurality of mating surfaces that abut the parallel ridges and nest within the furrows of the sub-floor.

6. The trailer of claim 1 wherein the deck floor and sub-floor form a semi-monocoque deck.

7. The trailer of claim 1 wherein the channels run longitudinally within the deck.

8. The trailer of claim 1 and electrical wiring extending through and enclosed within one of the plurality of channels.
